(19) United States
(12) Patent Application Publication
(10) Pub. No.: US 2005/0231975 A1
(43) Pub. Date: Oct. 20, 2005

(54) Hanging ornament with central light, lenses, and spires

(76) Inventors: Kevin L. Bixler, Littleton, CO (US); Deanna G. Bixler, Littleton, CO (US); Keith R. Bean, Johnstown, CO (US)

Correspondence Address: Barber Legal, PO Box 16220, Golden, CO, 80402-6004, US

(21) Appl. No.: 10/826,884

(22) Filed: Apr. 17, 2004

(51) Int. Cl. F21V 21/00

(52) U.S. Cl. 362/565; 362/806

(57) ABSTRACT

The present invention teaches a hanging ornament having a central core and a plurality of radiating spires. Each spire allows light to pass. An electrical cord having a plug suitable for connection to local electrical outlets leads to wiring within the core, which in turn provides electricity to a centrally located light bulb. Each spire is seated in a socket which connects one spire to the core. Lenses may advantageously be employed with the spires to focus the light. Light steps within the hollow spires may aid in light diffusion, for example by having surface areas in accordance with the inverse square law, or fiber optic bundles within the spires may serve the same purpose.

### CROSS REFERENCE TO RELATED APPLICATIONS

The present application is a continuation-in-part of U.S. patent application Ser. No. 10/403,776 filed Mar. 31, 2003 in the name of the same inventors, Kevin Bixler, Deanna Bixler, and Keith Bean. The specification of that application is incorporated herein by reference.

### FIELD OF THE INVENTION

This invention relates generally to ornaments and specifically to a lighted hanging ornament such as a star, a cross or having radiating elements, ornaments simulative of a star or snowflake, seasonal or religious ornaments or ornaments having plural light sources.

### BACKGROUND OF THE INVENTION

The present invention relates to ornaments such as are hung from trees at Christmas, Easter, Halloween, New Years, and numerous other holidays. Large ornaments such as the invention relates to are generally hung out of doors, but it is entirely practical to make such ornaments smaller in dimension and hang them inside, or from large indoor trees. Ornaments of the type may also be hung from supports other than trees. At least three types of lights may be used: miniature lights such as are commonly sold in the US at Christmas time, and sub-miniature lights, which are normally used for other purposes such as illuminating theater or airliner walkways. In addition, larger 115VAC lights such as size C-7½ and C-9 may be used. Such lights are available in a number of power ratings such as 25 W, 40 W, 60 W and so on.

A traditional item from Central Europe is the Moravian star. The Moravian star is a three dimensional star consisting entirely of points which extend outwards in all directions. All of the points are three sided or four sided pyramidal structures. One type on the market has a plastic framework which supports the bases of the plastic points: at the framework, the bases are adjacent to one another. A light may be installed in the middle of the structure and the points are hollow, without any internal or external features, so light may shine down the points of the star.

The applicant has carried out two searches using the classification system promulgated by the United States Patent and Trademark Office. Relevant prior art patent documents located are listed and discussed below.

Patent Publication No. US 2003/0016544, published Jan. 23, 2003 in the name Huang and entitled STRUCTURE OF FIREWORK LIGHT teaches a base having a single post projecting therefrom and a hollow ball upon the top of the post. Projecting from the hollow ball are numerous tubes which contain wiring leading to a plurality of small lights arranged in a generally spherical pattern at the end of each tube. It does not teach use of any transparent spires.

Patent Publication No. US 2002/0141184 published Oct. 3, 2002 in the name of Shieh and entitled GLOBULAR DECORATIVE LIGHT ASSEMBLY WITH FLEXIBLE SUPPORTING FRAME does not use radiating multiple spires of any type.

Patent Publication No. US 2002/0097577, published for opposition Jul. 25, 2002 in the name Huang and entitled MINI FIRECRACKER LIGHT teaches a single hollow transparent pipe having a plurality of lights within it, and further having a spray of lights projecting from the top of the pipe. It does not teach a central point from which a multiplicity of spires might radiate.

U.S. Pat. No. 6,394,624 issued May 28, 2002 to Hsu for DECORATIVE ARTIFICIAL ICICLE teaches a decoration with a transparent shell including a tubular body within having thereon a lampset of mini-lights. The device does not disclose a jig for use in manufacturing, a solid spire, nor a plurality of radiating spires, nor the use of sub-miniature lights. A related patent is U.S. Pat. No. 6,224,239 issued May 1, 2001 to Adler for DECORATIVE LAMP FIXTURE WITH ICICLE SHAPE HAVING INTERIOR WITH PLURALITY OF VERTICALLY-SPACE LIGHTS, in which the lights are retained on the inner wall of the icicle. Yet another icicle patent of dissimilar structure may be seen in U.S. Pat. No. 3,704,365 issued Nov. 28, 1972 to Miller.

U.S. Pat. No. 6,394,623 issued May 28, 2002 to Tsui for TRANSLUCENT FLEXIBLE ROPE LIGHT AND METHOD OF FORMING AND USING SAME teaches a flexible set of sub-miniature lights, and specifically mentions ornamental applications. The device does not teach a radiating set of rigid, molded, spires.

U.S. Pat. No. 6,312,141 issued Nov. 6, 2001 to Liu for SIMULATED FIREWORKS LAMP ASSEMBLY also concerns a light set for simulating a firework, as such firework simulations are popular for business advertisements in some regions of the world. Lights simulating the pattern of a firework explosion, and further simulating flight of sparks out the length of radiating “levers”. It does not teach rigid spires for a hanging ornament, nor the use of sub-miniature lights within solid transparent spires.

U.S. Pat. No. 6,070,991 issued Jun. 6, 2000 to Rumpel for DECORATIVE LIGHT FIXTURE teaches a spherical framework for mounting of lights. It does not use radiating spires of any type.

U.S. Pat. No. 6,036,335 issued Mar. 14, 2000 to Openiano for CUT-TO-LENGTH LINEAR LIGHTING, AND TWO-DIMENSIONAL AND THREE-DIMENSIONAL DECORATIVE LIGHTS, FROM OMNI-DIRECTIONAL LED LAMPS, teaches a type of linear lighting unrelated to ornaments and having no solid molded spires.

U.S. Pat. No. 5,865,533 issued Feb. 2, 1999 to Liu for IMITATED FIREWORKS BULB SET FOR CHRISTMAS TREE DECORATION teaches hollow spheres with sprays of fiber optic cables within.

U.S. Pat. No. 5,772,312 issued Jun. 30, 1998 to Pihl-Niederman et al for LIGHTED HOLIDAY ORNAMENT teaches a hollow spherical shell which houses a string of lights. Translucent members or apertures in the hollow shell allow light to escape the ornament. There are no transparent solid spires.

U.S. Pat. No. 5,645,343 issued Jul. 8, 1997 to Rinehimer for LIGHT-STRING HOLDER teaches a light string holder in a generally spherical shape comprising a plurality of translucent lamp-cluster holders. There are no spires. U.S. Pat. No. 5,876,111 issued Mar. 2, 1999 to Wu for DECORATIVE LIGHTING STRING WITH EXPANDABLE, SHRINKABLE AND THREE-DIMENSIONAL UNIT is generally similar.

Two patents relating to retention of lights on a structural member are U.S. Pat. No. 5,526,246 issued Jun. 11, 1996 to Liou for POSITIONING STRUCTURE FOR A PATTERN OF A DECORATIVE LAMP STRING, and U.S. Pat. No. 5,664,877 issued Sep. 9, 1997 to Wu for DECORATIVE LAMP STRING ASSEMBLY teach multi-piece retainers using clips to retain a string of minilights (not sub-miniature lights) on a strip of material. The retainer does not appear to function as a jig in making a larger SOLID structure.

U.S. Pat. No. 4,665,470 issued May 12, 1987 to George, Jr, for DECORATIVE LIGHT TUBING AND METHOD OF MANUFACTURE THEREOF teaches that a hollow tube may enclose a string of lights and a protective dielectric material for cushioning against moisture, shock and vibration. It does not teach a hanging ornament having multiple rigid and solid spires.

U.S. Pat. No. 4,179,832 issued Dec. 25, 1979 to Lemelson for INFLATABLE DISPLAYS teaches an inflatable (non-solid) display having lights within a flexible transparent structure possibly simulating a Christmas tree shape.

U.S. Pat. No. 3,755,663 issued Aug. 28, 1973 to George, Jr. for ELECTRICAL DISPLAY DEVICE AND METHOD OF MAKING THE SAME teaches a string of miniature (sub-miniature?) lights in a flexible housing. It discloses that such devices may be bent into decorative shapes, unlike most patents in the unrelated “lighting” technology. However, it does not disclose use of solid molded radiating spires.

U.S. Pat. No. 3,272,976 issued Sep. 13, 1966 to Charchan et al for STAR SHAPED ORNAMENT teaches a star shaped ornament supporting mini-lights rather than sub-miniature lights. It further lacks transparent spires. U.S. Pat. No. 6,179,442 issued Jan. 30, 2001 to Schurle for CHRISTMAS STAR LIGHT DEVICE teaches a modular lighted light construction set which does not appear to use solid molded spires, while U.S. Pat. No. 5,430,626 issued Jul. 4, 1995 to Leffel for ILLUMINATED DISPLAY CONSTRUCTION also teaches light up stars, as does U.S. Pat. No. 6,478,455 issued Nov. 12, 2002 to Ahroni for DECORATIVE LIGHTING APPARATUS.

Additional searching reveals further references from the US Patent Office database.

US Patent Publication No. 2003/0147235 issued Aug. 7, 2003 to Lin et al for FIBER OPTIC MUSICAL WATER GLOBE teaches a device using a light and a bundle of fiber optic cables to illuminate a globe.

U.S. Pat. No. 6,494,591 issued Dec. 17, 2002 to Guimond for ORNAMENTAL LIGHTING DEVICE teaches a cross between traditional track lighting and Christmas lights, with covers on individual lights.

U.S. Pat. No. 6,474,858 issued Nov. 5, 2002 to Liao for ILLUMINATION DEVICE WITH AN OUTER TUBE ENCASING A TRANSPARENT CENTER ROD teaches a Christmas light shining upwards into a tube with a transparent center rod.

U.S. Pat. No. 5,918,967 issued Jul. 6, 1999 to Land for DECORATIVE LAMP CASINGS AND LAMP BULB ENVELOPES teaches a casing which slides over a Christmas light with a frictional fit to make the appearance of a pendant icicle.

U.S. Pat. No. 5,653,530 issued Aug. 5, 1997 to Pittman for ORNAMENTAL LIGHTING DEVICE teaches a device with a socket for a light at one end of a pendent prism.

U.S. Pat. No. 4,782,434 issued Nov. 1, 1988 to Cole for LIGHTING UNITS teaches some form of star shaped ornament with several lights inside.

U.S. Pat. No. 4,693,541 issued Sep. 15, 1987 to Sanders et al for ELECTRICAL ORNAMENTATION SYSTEM teaches an electrical socket adapter for differing types of Christmas lights.

U.S. Pat. No. 4,364,102 issued Dec. 14, 1982 to Huppert et al for INTERNALLY LIGHTED DECORATIVE DISPLAY teaches a hollow tree or wreath.

U.S. Pat. No. 2,749,432 issued Jun. 5, 1956 to R. T. Dorsey for INCANDESCENT LAMP AND ATTACHMENTS THEREFOR, and U.S. Pat. No. 5,911,501 issued Jun. 15, 1999 to Katz HOME DECORATION SYSTEM, and U.S. Pat. No. 5,931,568 issued Aug. 3, 1999 to Chuang for CHRISTMAS LAMP STRUCTURE, U.S. Pat. No. 6,398,387 issued Jun. 4, 2002 to Wienhold for ICICLE LIGHT CANDY CANE, and US Patent Publication No. 2002/0080608 (same information as the citation to the '387 patent), and US Patent Publication No. 2002/0191399 issued Dec. 19, 2002 to Chen for DESIGNED SHELL FOR CHRISTMAS ORNAMENTAL BALL all teach variations on plugging a light into an ornament of another type: a fruit, a pumpkin, candy canes and so on.

U.S. Pat. No. 2,569,078 issued Sep. 25, 1951 to L. H. Silver et al for SUPPORT FOR BUBBLE LIGHT DEVICE, and U.S. Pat. No. 2,741,693 issued Apr. 10, 1956 to E. C. Fasson for ILLUMINATED DYNAMIC FLUID ORNAMENTAL DEVICE, and U.S. Pat. No. 4,011,444 issued Mar. 8, 1977 to Levy for LAMP ASSEMBLY, and U.S. Pat. No. 2,530,794 issued Nov. 21, 1950 to A. Tiscione for BUBBLING FLUID ORNAMENTAL DISPLAY DEVICE teach the general “bubbling light” type of devices.

U.S. Pat. No. 2,248,117 issued Jul. 8, 1941 to J. Petry for ELECTRIC LIGHTED ORNAMENTAL DEVICE teaches a light with holes to allow light to radiate sideways while a reflector of a desired shape such as a flower or sunburst shape reflects that light.

It would be desirable to provide a method of using a single light source to provide a richly illuminated snow flake or ice crystal shape.

### SUMMARY OF THE INVENTION

General Summary

The present invention teaches a hanging ornament having a central core and a plurality of radiating spires. Each spire allows light to pass. An electrical cord having a plug suitable for connection to local electrical outlets leads to wiring within the core, which in turn provides electricity to a centrally located light bulb. Each spire is seated in a socket which connects one spire to the core. Each spire may be removed individually, this provides space saving storage of the invention. In embodiments, the light of the core may be Christmas lights such as a C-7½ socket bulb, C-9, G16.5, B10 bulb, a mini light, a sub-miniature light, a light emitting diode, a high intensity light emitting diodes or combinations thereof. In other embodiments, the light passing spires may be textured, transparent, translucent, clear or colored, and in yet other embodiments, removable sheaths may be employed on the spires to provide color and/or texture to the spires and to the light emitted by the spires.

Lenses may advantageously be employed with the spires to focus the light. The core may be a light color on its internal surface, so as to reflect light inside the core until it can escape via a spire/lense. Light steps within the hollow spires may aid in light diffusion, for example by having surface areas in accordance with the inverse square law, or fiber optic bundles within the spires may serve the same purpose.

Various other embodiments are detailed in the body of the present document.

Summary in Reference to Claims

It is therefore a first objective, advantage, aspect and embodiment to provide a hanging holiday ornament comprising: an electrical cord having a plug at a first end, the electrical cord terminating at a light bulb at the second end; a hollow core having a plurality of sockets and having disposed therein the light bulb, and having a plurality of exterior facets; a plurality of decoratively faceted light passing spires extending radially from the core; each spire physically connected to one of the sockets.

It is therefore yet another objective, advantage, aspect and embodiment to provide an ornament, wherein each of the plurality of light passing spires is furthermore hollow.

It is therefore another objective, aspect, advantage, and embodiment to provide an ornament wherein the plurality of light passing spires extend from the core in at least two dimensions.

It is therefore yet another objective, advantage, aspect and embodiment to provide an ornament, wherein the core further comprises an interior which reflects light.

It is therefore yet another objective, advantage, aspect and embodiment to provide an ornament, wherein the core further comprises a first portion which may be removed to allow access to the light bulb.

It is therefore yet another objective, advantage, aspect and embodiment to provide an ornament comprising: an electrical cord having a plug at a first end, the electrical cord terminating at a light bulb at the second end; a hollow core having a plurality of sockets and having disposed therein the light bulb; a plurality of light passing spires extending radially from the core; each spire physically connected to one of the sockets; and a plurality of lenses, at least one lens being disposed so as to focus light from the light bulb up at least one of the light passing spires.

It is therefore yet another objective, advantage, aspect and embodiment to provide an ornament, wherein the at least one lens focuses light from the light bulb up the at least one light passing spire so as to increase the amount of light emitted by the portions of the spire further from the base.

It is therefore yet another objective, advantage, aspect and embodiment to provide an ornament, wherein at least one of the plurality of lenses is partially disposed within at least one of the light passing spires.

It is therefore yet another objective, advantage, aspect and embodiment to provide an ornament, wherein at least one of the plurality of lenses is partially disposed within at least one of the sockets.

It is therefore yet another objective, advantage, aspect and embodiment to provide an ornament, wherein at least one of the plurality of lenses is partially disposed within the hollow core.

It is therefore yet another objective, advantage, aspect and embodiment to provide an ornament, wherein each light passing spire further comprises: a plurality of light steps oriented so as to receive light from the light bulb via the hollow of the spire; a plurality of facets, each facet oriented so as to receive light from at least one of the light steps.

It is therefore yet another objective, advantage, aspect and embodiment to provide an ornament, wherein each one of the light steps has an area and a distance from the light bulb, and wherein the relative areas of the light steps are functions of relative distances from the light bulb.

It is therefore yet another objective, advantage, aspect and embodiment to provide an ornament, wherein the relationship is the inverse square law.

It is therefore yet another objective, advantage, aspect and embodiment to provide an ornament, wherein the spires are rigid.

It is therefore yet another objective, advantage, aspect and embodiment to provide an ornament, wherein the spires are flexible.

It is therefore yet another objective, advantage, aspect and embodiment to provide an ornament, wherein each spire is dimensioned and configured, and each socket is dimensioned and configured, such that each spire may be individually removed from the socket to which it is physically connected.

It is therefore yet another objective, advantage, aspect and embodiment to provide an ornament, wherein the socket and spire base each have at least one notch and at least one tab which overlap when then the spire base is inserted into the socket and rotated.

It is therefore yet another objective, advantage, aspect and embodiment to provide an ornament, wherein the exterior of the spires comprises a texture selected from the group consisting of: smooth texture, faceted texture, knurled texture, straight grooved texture, spiraled grooved texture, and combinations thereof.

It is therefore yet another objective, advantage, aspect and embodiment to provide an ornament, wherein one member selected from the group consisting of: a spire, a lense, a shell half and combinations thereof further comprises a material selected from the group consisting of: clear polycarbonate, transparent colored polycarbonate, pearlescent polycarbonate, clear polymer, transparent colored polymer, translucent polymer, pearlescent polymer, clear glass, transparent colored glass, translucent glass, pearlescent glass, and combinations thereof.

It is therefore yet another objective, advantage, aspect and embodiment to provide an ornament, wherein the polymer is selected from the group consisting of clear hard PVC, acrylic, PETG, LDPE, HDPE, and combinations thereof.

It is therefore yet another objective, advantage, aspect and embodiment to provide an ornament, wherein each spire further comprises: at least one removable light passing sheath covering the exterior surface of the spire, wherein the light passing sheath is selected from the group consisting of: clear polycarbonate, transparent colored polycarbonate, pearlescent polycarbonate, clear polymer, transparent colored polymer, translucent polymer, pearlescent polymer, clear glass, transparent colored glass, translucent glass, pearlescent glass, and combinations thereof.

It is therefore yet another objective, advantage, aspect and embodiment to provide an ornament, wherein the light bulb is colored.

It is therefore yet another objective, advantage, aspect and embodiment to provide an ornament, further comprising means for timed control of the electrical supply of the light bulb.

It is therefore yet another objective, advantage, aspect and embodiment to provide an ornament, further comprising: at least one electrically actuated sound device in operative connection to the electrical cord, whereby the device may make sound when in operation.

It is therefore yet another objective, advantage, aspect and embodiment to provide an ornament, wherein a first one of the plurality of spires has a first length, and a second one of the plurality of spires has a second length.

It is therefore yet another objective, advantage, aspect and embodiment to provide an ornament, further comprising a photoelectric control circuit regulating electrical supply to the light bulb based upon ambient light.

### BRIEF DESCRIPTION OF THE DRAWINGS

FIG. 1 is a partially exploded perspective view of the invention.

FIG. 2 an elevated perspective view of one half of the core's shell.

FIG. 3 is a side view of one portion of the core's shell.

FIG. 4 is an elevated perspective view from the bottom of one half of the core's shell.

FIG. 5 is a perspective elevational view of one spire.

FIG. 6 is a cross-sectional view of one spire.

FIG. 7 is an elevated perspective view of one lense.

FIG. 8 is a side view of one lense.

FIG. 9 is a top view of one lense.

FIG. 10 is a frontal view of one lense.

FIG. 11 is a perspective view of the electrical cord and light bulb of the invention.

FIG. 12 is an orthogonal (non-perspective) view of a fiber optic bundle according to an alternative embodiment of the invention.

### INDEX TO REFERENCE NUMERALS

| | |
|---|---|
| First Embodiment | 10 |
| Electrical Cord | 20 |
| Shell Half | 30 |
| Spire | 40, 42 |
| Spire Half | 44 |
| Lense | 50 |
| Light Bulb Socket | 60 |
| Spire Socket | 70 |
| Drain Hole | 80 |
| Facet | 90 |
| Seal | 100 |
| Socket Hole | 110 |
| Vent hole | 120 |
| Rain block | 125 |
| Bump | 130 |
| Hole | 140 |
| Hollow Spire Interior | 145 |
| Tab | 150 |
| Stop | 160 |
| Notch | 170 |
| Lens Extraction | 175 |
| Point | |
| Spire Facet | 180 |
| Spire Groove | 190 |
| Light Step | 200 |
| Lens Face | 210 |
| Lens Extension | 230 |
| Lens Shoulder | 240 |
| Light Source/bulb | 260 |
| Rib | 270 |
| Bundle/Fiber Base | 280 |
| Elliptical Face | 290 |

### DETAILED DESCRIPTION

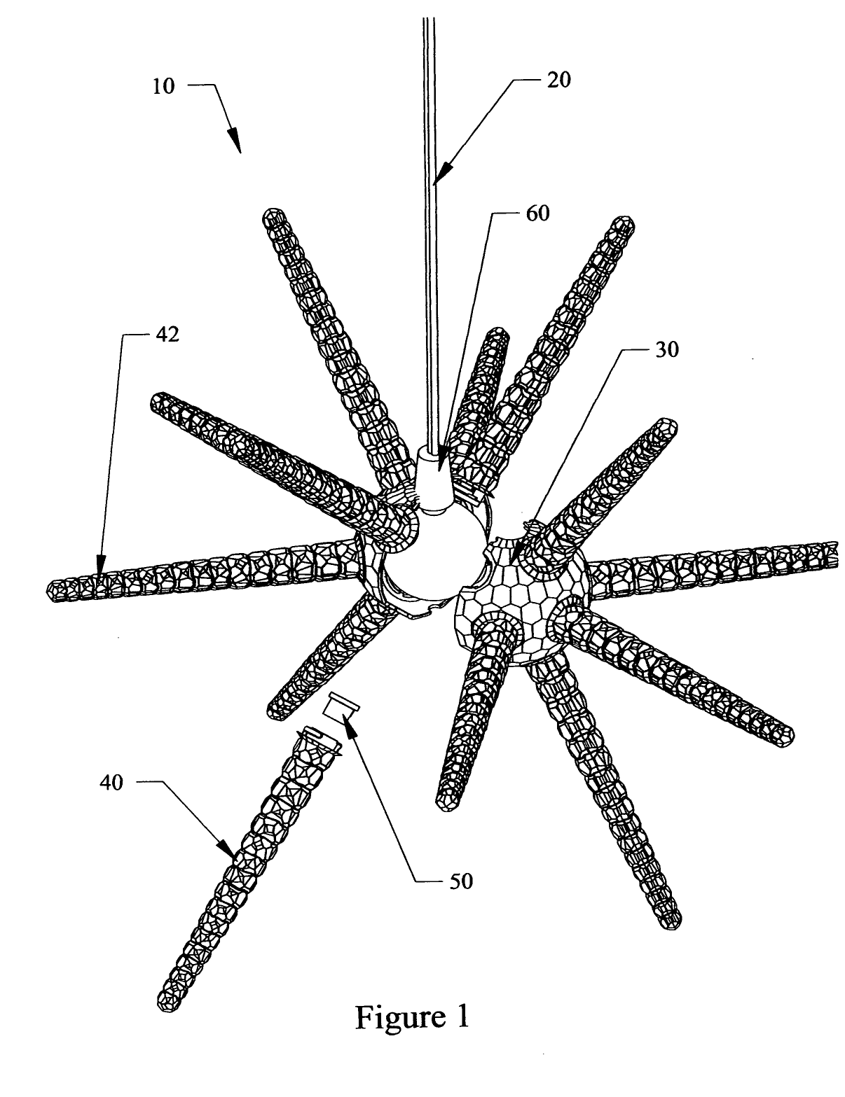

FIG. 1 is a partially exploded perspective view of the invention according to a first, presently preferred embodiment and best mode now contemplated. The invention is a hanging ornament 10 intended to be suspended from such locations as trees, eaves, balconies or other overhanging structures or flora.

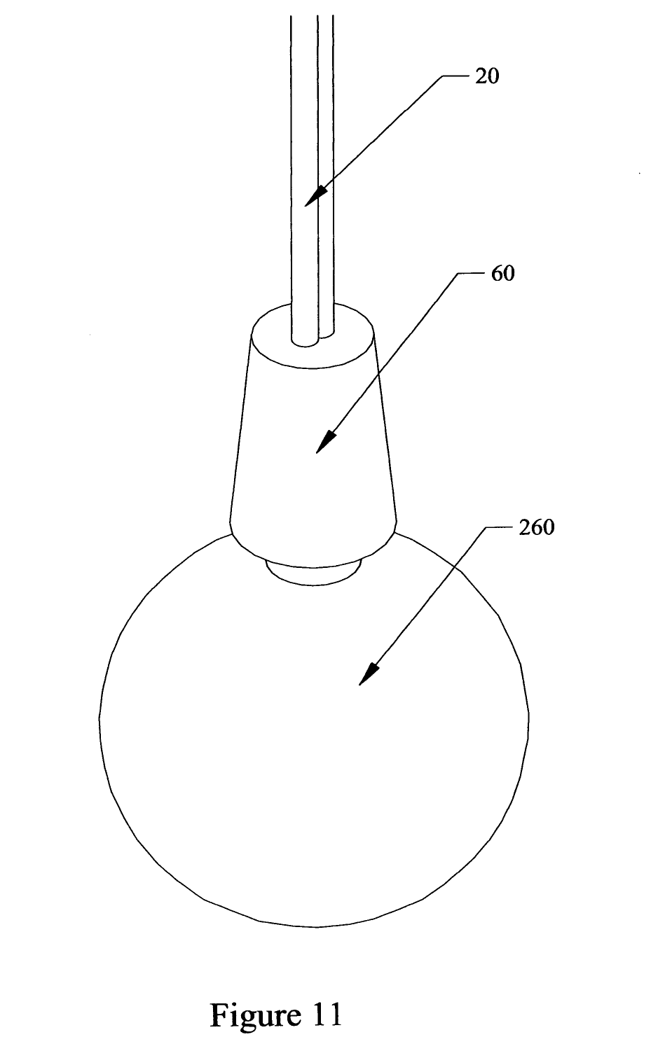

Electrical cord 20 has a plug not shown. Electrical cord 20 may serve as the suspension device or a separate suspension device may be employed. Strain relief devices may be employed with the electrical cord, although in the presently preferred embodiment, that is handled by other means. Plug and electrical cord may be dimensioned and configured to comply with US standards for outlet configuration, safety standards and so on, however, this can be varied to suit local conditions. Electrical cord 20 enters the ornament core where it is operatively connected to light bulb socket 60 and thus to light source/bulb 260 shown in FIG. 11, a perspective view of the electrical cord and light source/bulb of the invention.

Source/bulb 260 may be a C-7½, C-9, G16.5, B10 or other standard sized incandescent bulb, a LED, a fluorescent light, or similar device.

Source/bulb 260 may have roughly 1/10 of an inch of clearance on all sides in the presently favored embodiment, however, other clearances may be used, or non-spherical cores may be used. The rain blocks may be located, dimensioned and configured to prevent motion of the bulb socket into the interior of the core, thus preventing the bulb from smashing the bottom of the core interior, but may be large enough to allow the narrow neck of bulb 260 to screw into the bulb socket.

The core may be generally spherical as in the best mode now contemplated, or it may be another shape or size. The core is comprised of a shell made up of two shell halves such as shell half 30. A plurality of light passing spires 40, 42, etc extend radially from the core shell halves 30. The plurality of spires in the preferred embodiment shown is 14 total spires, however, any number of spires may be employed from 2 to whatever is practicable. The arrangement of the spires may be varied to be symmetrical for the number of spires employed, or the spires may be asymmetrical. The arrangement may also be left to the user, as the individual spires are removable and replaceable. The lengths of the spires may vary from spire to spire in order to provide a more pleasing star or cross shape, for example one spire may have a first length while another spire may have a second length, and so on. The form of the individual spires will be discussed further later.

While the term radially is used to describe the extension of the spires from the core, it is to be understood that this term is not used in the purely geometric sense, that is, the spires may extend from a point other than the geometric center of the invention, the spires may extend in angles which are not precisely radial, thus forming patterns among several spires, or the spires may be curved or bent or branched.

The core may also be equipped with convection cooling vent 120, having rain block 125 to prevent rain drops from directly striking source/bulb 260. In the presently preferred embodiment, the device actually has two such ports (and one drain hole 80), thus allowing circulation of cool air into the drain while hotter air flows out the vent holes. This air circulation is viewed as an important safety precaution: limiting the core temperature reduces fire danger from overheating. Block 125 may prevent socket 60 from passing too far into the core.

It will be seen that the sockets are apertures into the interior of the core. Thus the core is a shell having an interior cavity and having apertures extending from the cavity to the exterior of the core. The interior surface of the core may be reflective or partially reflective, so as to induce further light penetration up the light passing spires. For example, in the presently preferred embodiment and best mode now contemplated, the core material may be a semi-translucent white material, thus allowing some light to pass through for a pleasing effect, while much light is reflected within the core until it encounters a lens or light passing spire base.

In order to ease manufacturing burden, core hemispheres (shell half 30) may be identical to the matching core hemisphere to which it is attached to form the core. By such methods, a single mold may be used to manufacture a two part core.

Lens 50 extends into light spire 40 at the base of the spire, as will be discussed.

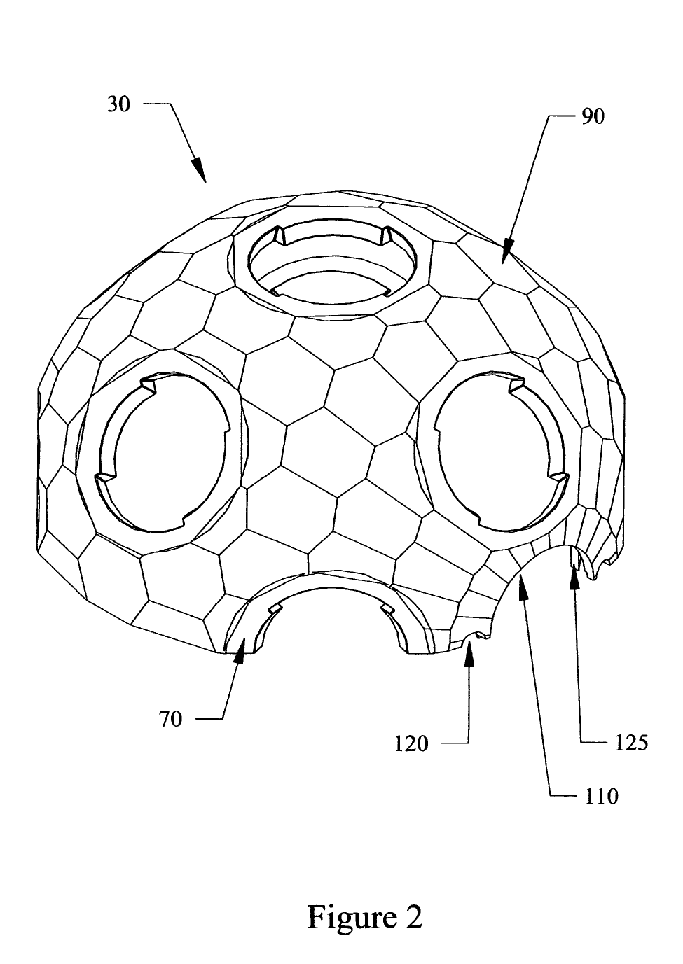

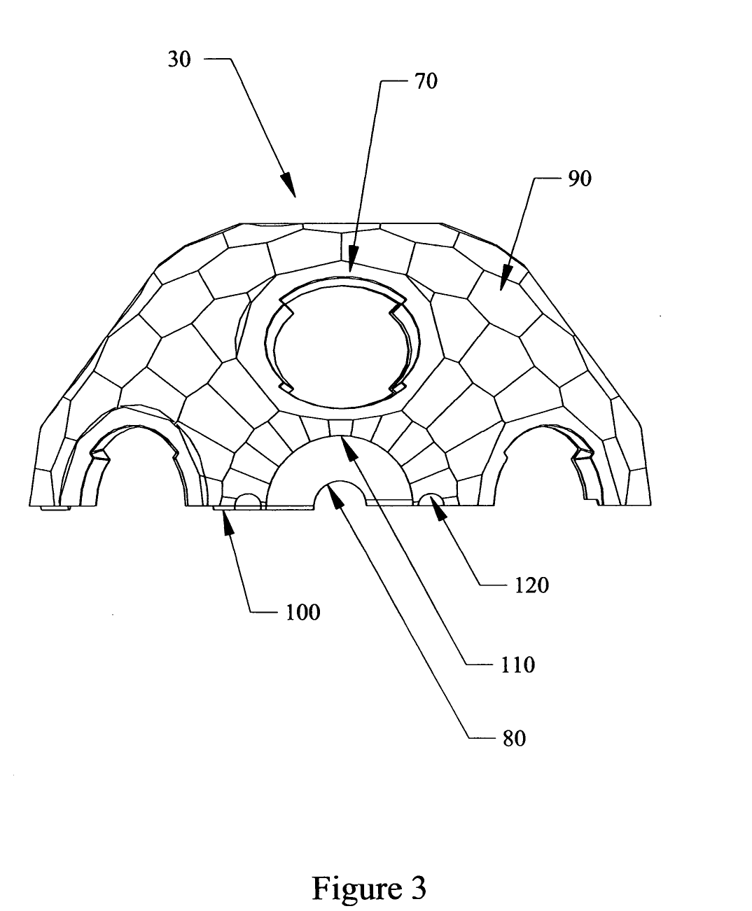

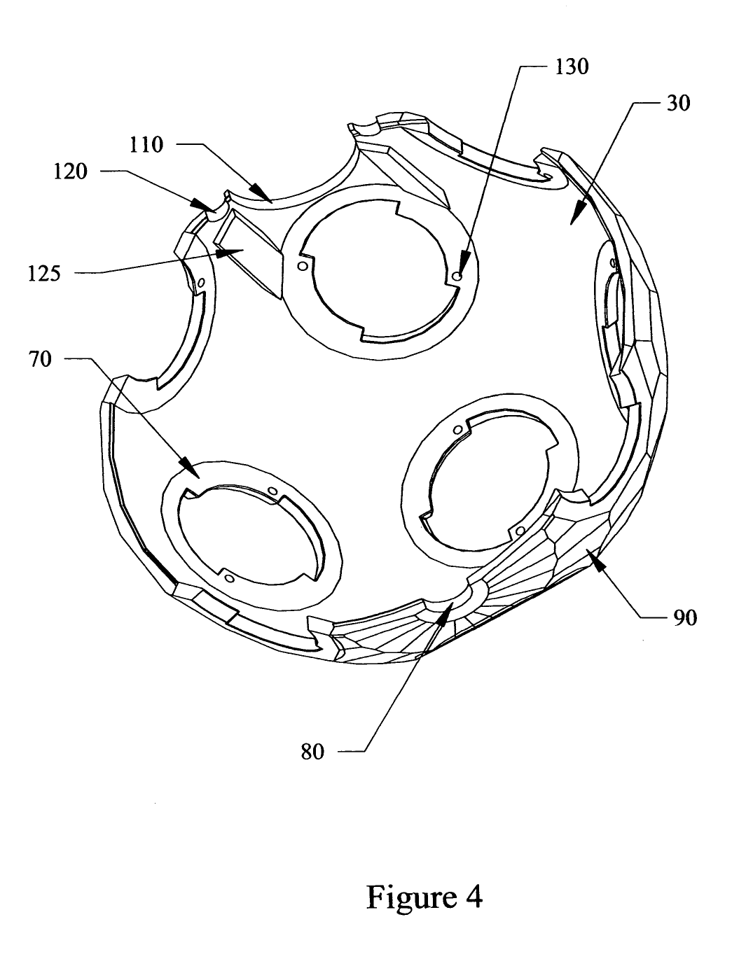

FIG. 2 an elevated perspective view of one half of the core's shell, FIG. 3 is a side view of one portion of the core's shell, and FIG. 4 is an inverted side view of the assembled core. Shell half 30 has spire socket 70 into which spire 40 may be inserted and secured. Drain hole 80 is located at the bottom of the core when the invention is assembled and hung properly. Drain hole 80 allows moisture to drain from the core. Moisture may obviously occur as condensate, by running down the electrical cord 20, as snow, rain, sleet, etc. Facet 90 shows that while the core is generally spherical, it may be made in faceted shapes, irregular shapes, geometrical shapes and so on. Facet 90 may contribute to the appeal of the device, may reduce the cost of manufacture, increase safety and serve other functions. Facets may be located on the interior of the core in embodiments, or upon both the interior and the exterior of the core. Seal 100 overlaps into a mating shell half (not shown) to help in sealing the assembled device against moisture. Socket hole 110 may have hole shoulder 120 so as to increase strength or provide dimensional fit to the socket 60 or for other reasons.

Bump 130 in spire socket 70 may provide a secure interference fit between the base of the spire inserted and the socket 70 into which it is inserted. This may be a small partial hemispherical as in the preferred embodiment or another shape and dimension.

It will be seen that the overall device functions as an optical system. Lens parameters such as focal length and light gathering capacity or aperture, spire lengths, internal reflective properties of the core (the core may act as a reflector to concentrate light into lenses or spires in various embodiments) and spire configuration are all parts of the optical system as will be discussed below.

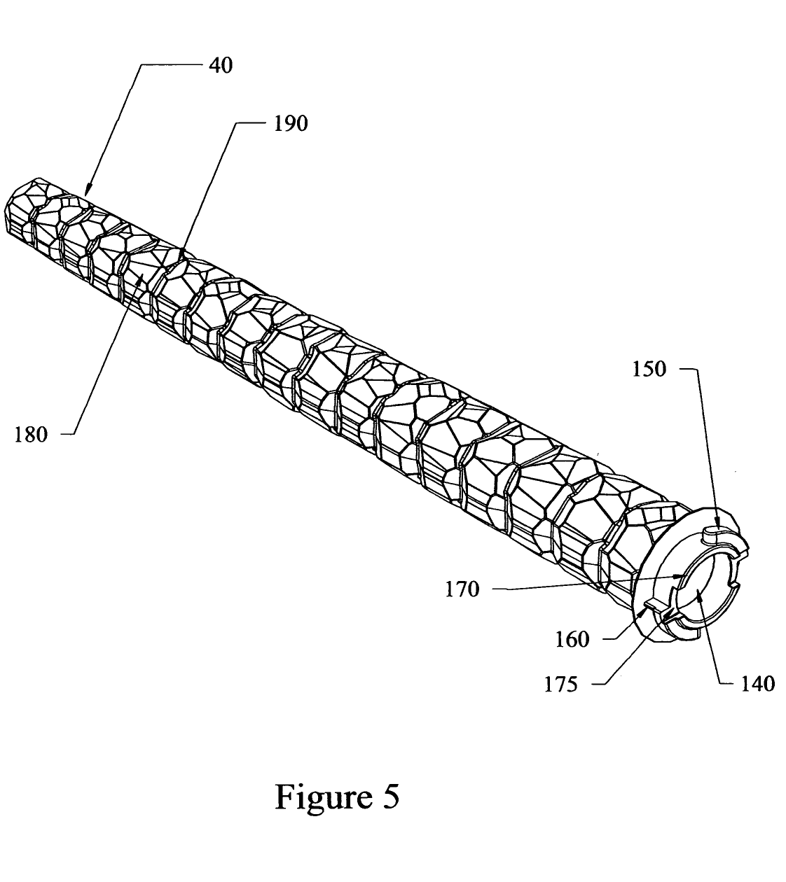

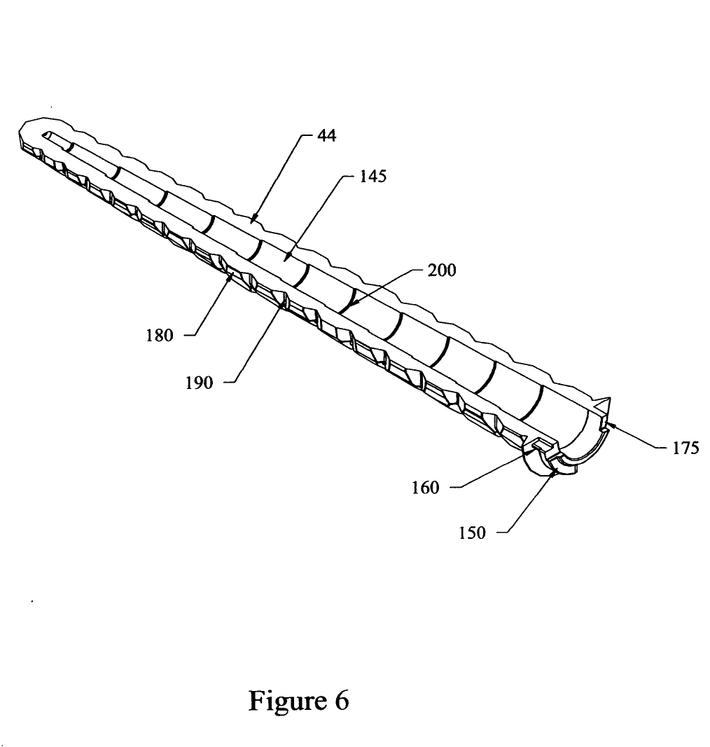

FIG. 5 is a perspective elevational view of one spire 40; FIG. 6 is a cross-sectional view of spire 40. Spire 40 has a hole 140 leading to a hollow interior 145. Hole 140 is located at the base of spire 40, where tab 150, stop 160 and notch 170 are dimensioned and configured to physically cooperate with socket 70, bump 130, and tab 150 so as to allow the spire base to be inserted into the socket and turned to provide a rotational engagement and interference fit therebetween, thus securing the two together.

Spire 40 also has spire facet 180 defined by spire groove 190 on the exterior thereof. In other embodiments, other arrangements of the spire exterior are possible: smooth, irregular, regular geometric bodies and so on. However, in the presently preferred embodiment, spire facets 180 and spire grooves 190 will cooperate with light steps 200 (located on the interior of the spire 40) to focus and define the shine of light within the spire. Decorative facets, as used herein, are facets in excess of the number on a simple regular pyramidal or conical shape having 3 sides, 4 sides, etc, or a plain conical surface. Decorative facets, on the other hand, may cause the overall spire shape to be irregular, may be present in greater quantities than necessary to define a simple pyramidal shape, may be individually of irregular shape, may be arranged in eye-pleasing patterns and so on.

In certain embodiments such as in the spires diagramed, light steps may be used. Light steps 200 may be either grooves or completely defined steps in the interior surface of spire 40 which catch light as it travels up the spire from the light source/bulb 260. In the best mode now contemplated, the light steps 200 are actually set orthogonal or perpendicular to the light rays emanating from light source/bulb 260, and each light step 200 is at the outside radius either approximately the same diameter or slightly larger or smaller than the light step immediately preceding it, that is, the light steps cause the interior diameter of the hollow interior 145 to decrease in increments in the preferred embodiment. The light steps may be rounded, filleted, angled and so on so as to provide desired optical properties.

The size of the light step 200 may be decided by the relative brightness desired at a given longitudinal location of the spire, or by manufacturing convenience, or, as in the best mode now contemplated, the relative surface areas of the light steps may depend upon the inverse square law governing radiation from a point source.

The refractive index of the material of the spire may be selected or altered so as to result in effective and efficient bending of light rays or diffusion of light rays from direct straight line radiation from the light bulb to an angle therefrom. The angle of the light steps may also be adjusted from purely perpendicular to other angles (for example an oblique angle slanting from interior hollow 145 wall towards the extreme tip of the spire 40) so as to further bend or diffuse light rays.

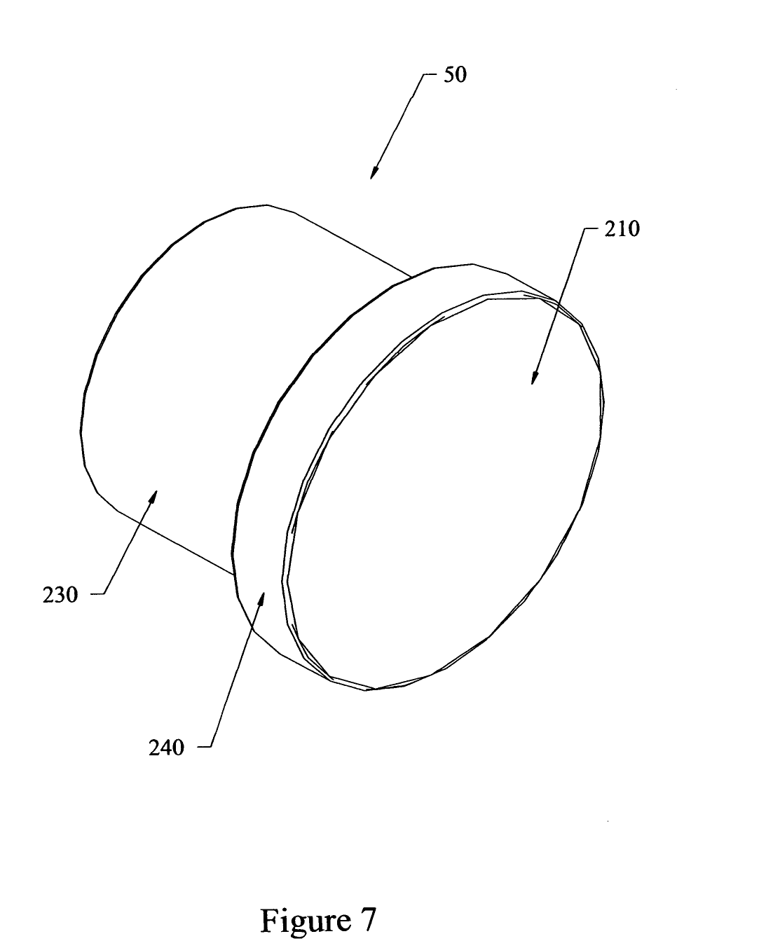

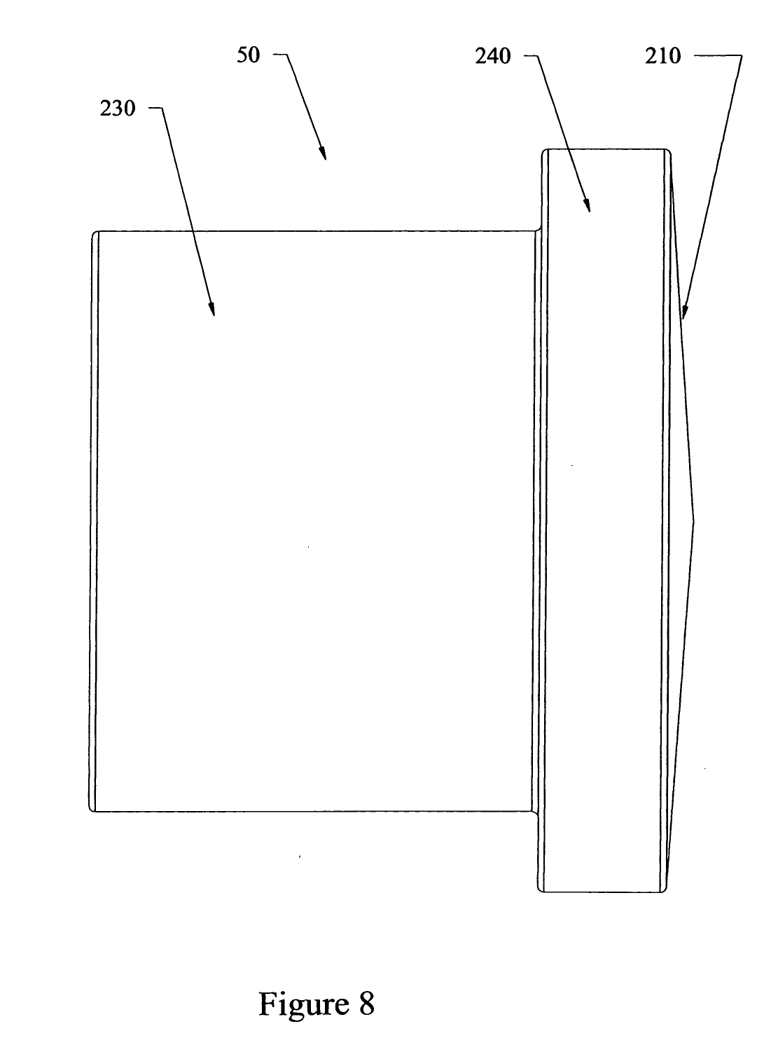

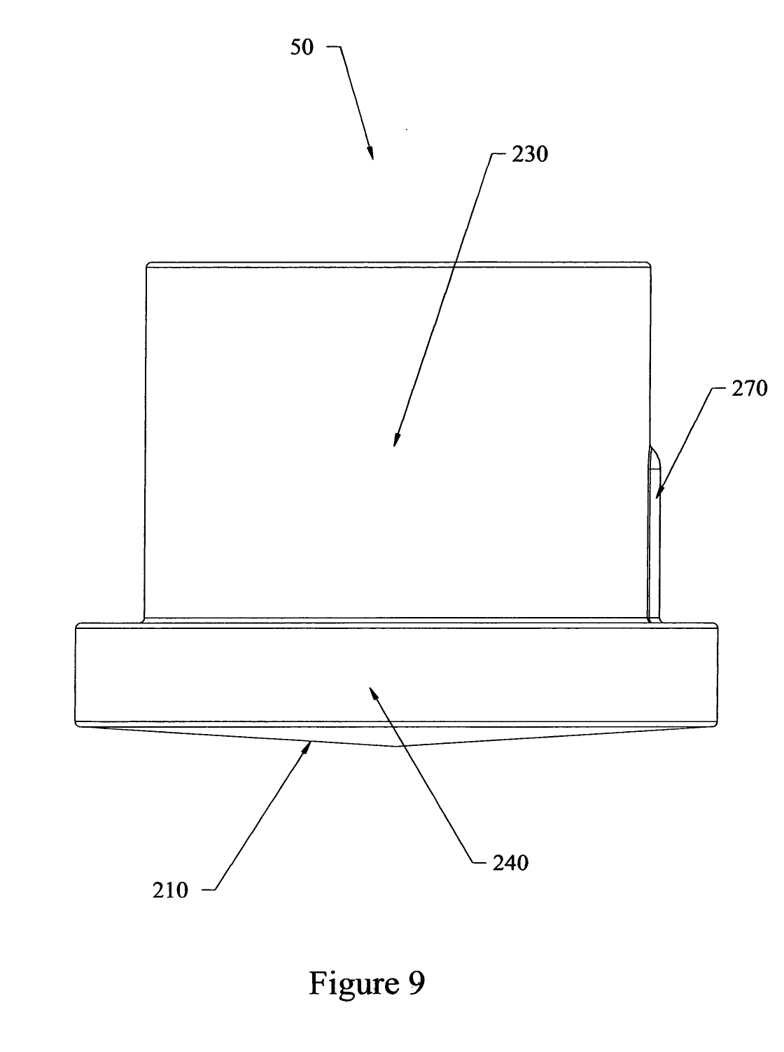

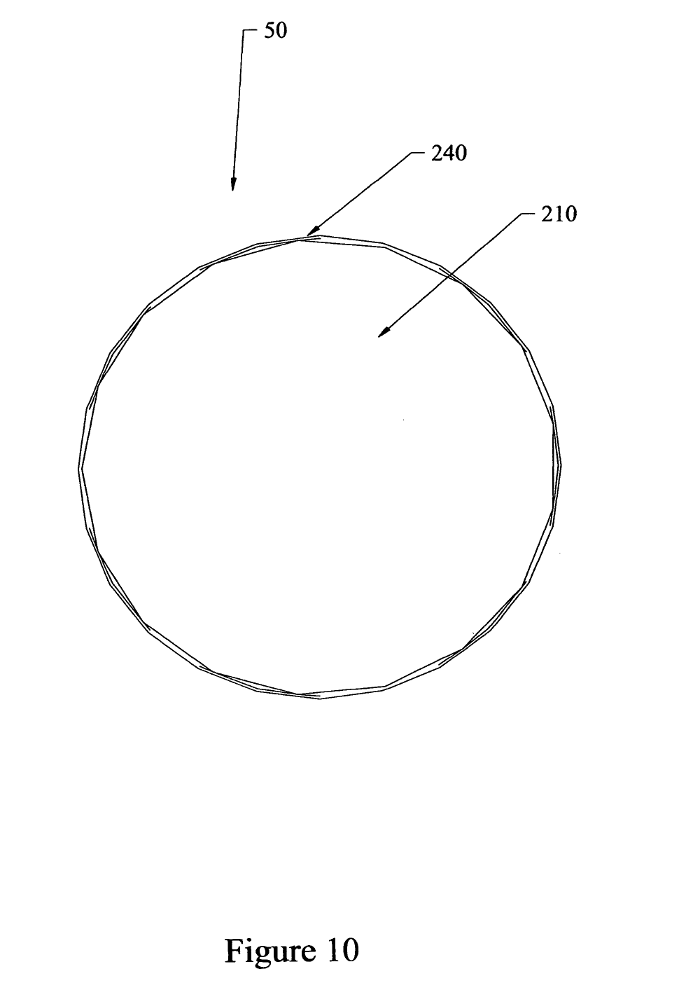

FIG. 7 is an elevated perspective view of one lens 50, FIG. 8 is a side view, FIG. 9 is a top view of lens 50, and FIG. 10 is a frontal view of that lense. Lens face 210 is slightly convex or concave as desired to alter the light rays passing therethrough: in the best mode now contemplated, the lens is a spherical lens having a focal length of roughly 1.111 inches (about 28 mm) and a radius of curvature of about 2.222 inches. Alteration of lens 50 may further alter the travel of light rays passing therethrough.

The result of correct dimensioning of the optical system created by the lense, source/bulb, spire and core interior is to focus light from the light source/bulb up the spires. In particular, it is desirable for aesthetic reasons to cause the portions of the spire further from the base, core and bulb to emit increased light.

Lens extension 230 fits into the hollow interior 145 of spire 40 at hole 140, thus securing lens 50 in the proper location and orientation. Lens extension 230 may be a hollow cylinder, open at one end. Lens shoulder 240 butts up against the spire base. Lens extraction point 175 is a small notch which allows a user to insert the tip of a small screwdriver or similar implement under lens shoulder 240 and thus extract lens 50 from spire 40. Rib 270 provides an interference fit between the lens extension 230 and the surface of the hollow interior 145.

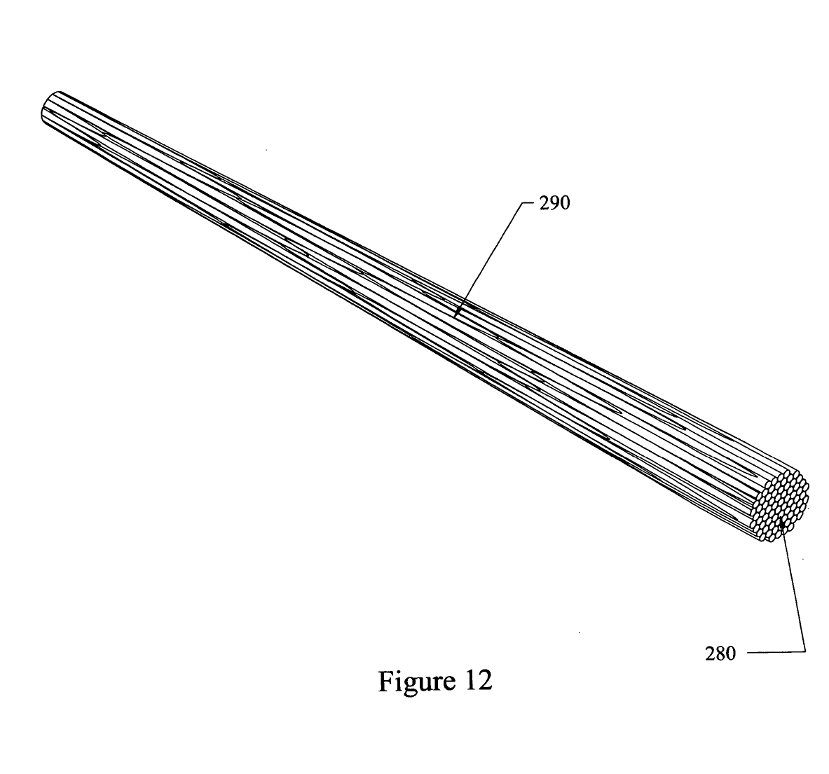

FIG. 12 is an orthogonal (non-perspective) view of a fiber optic bundle according to an alternative embodiment of the invention. Base 280, the base of the bundle, comprises a plurality of individual fiber optic strand bases as well.

The diagram is not irregular of line, rather the sides of the bundle are angled, while the individual strands are not oriented at that same angle. This means that the strands near the side of the bundle are cut, resulting in the upper ends of the individual fibers being extremely elongated elliptical faces 290. Some strands near the center of the bundle may not be so cut. In other alternative bundle embodiments, other arrangements may be possible.

In the invention, a bundle is inserted and secured into a spire with the base of the bundle at the base of the spire, where it is well positioned to receive light rays from the central light source. That light is conveyed up the individual fibers. As the fibers end at various locations, light is radiated at the fiber ends, at the elliptical faces 290. Other light rays in other fibers may proceed all the way to the end of the bundle, located well up the spire or even at the end of the spire. This aids in providing a uniform “shine” or “loom” of light from the spire.

Obviously, in other alternative embodiments, the individual strands may not be cut but rather may be turned to face the local side of the spire, and disposed as desired along the length and circumference of the spire. Thus by suitable rearranging of the fibers of the bundle, the light emanating from the spire may be arranged in concentric rings, long lines or bands, other patterns, may be concentrated at or the distal end of the spire or another part of the spire and so on.

Commercial success of the product has been demonstrated by a very positive response on the part of holiday products retailers, distributors and makers.

At the present time, the preferred polymer for the invention is polycarbonate: factors which favor it's selection include the fact that it has approximately 36 times the impact resistance of acrylic, provides favorable light channels, and so on. For example, switching from acrylic to urethane is presently disfavored as it has only one tenth the impact resistance of acrylic. Other polymers may be used based upon refractive index, light transmission, color, impact resistance, cost and so on.

The invention may be glued together but in the preferred embodiment it is not. This allows easy replacement of broken spires, burned out light bulbs, changing of the shape and configuration, replacement of spires having one look or color with spires having a newly preferred look or color, storage, shipping and handling.

In other embodiments, spire 40 may screw in (with screw threads on the spire base and in the socket), or may snap in by equivalent structures, etc.

Core circuitry for timed control of electrical current to the light source/bulb may be used to provide a variety of effects such as flashing the entire invention, dimming it or brightening it gradually, causing some spires to flash and others to stay lit, or to otherwise control light emitted. In embodiments, a photoelectric control circuit regulating electrical supply to the light source/bulb based upon ambient light may be included so as to cause the device to become dimmer, brighter, activated or deactivated due to varying light levels.

Additional circuitry may cause the device to make holiday music or other sounds.

The device may be small enough to fit on a string of equivalent lights on a small Christmas tree, or may be large enough to illuminate a large area at New Years. It may be used for numerous holidays: Halloween, Thanksgiving, Winterfest, Octoberfest and so on.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A hanging holiday ornament comprising:
an electrical cord having a plug at a first end, the electrical cord terminating at a light source at the second end;
a hollow core having a plurality of sockets and having disposed therein the light source;
a plurality of decoratively faceted light passing spires extending radially from the core;
each spire physically connected to one of the sockets.

2. The ornament of claim 1, wherein each of the plurality of light passing spires is furthermore hollow.

3. The ornament of claim 1, wherein the plurality of light passing spires extend from the core in at least two dimensions.

4. The ornament of claim 1, wherein the core further comprises an interior which reflects light.

5. The ornament of claim 3, wherein the core further comprises a first portion which may be removed to allow access to the light source.

6. A hanging holiday ornament comprising:
an electrical cord having a plug at a first end, the electrical cord terminating at a light source at the second end;
a hollow core having a plurality of sockets and having disposed therein the light source;
a plurality of light passing spires extending radially from the core; each spire physically connected to one of the sockets; and
a plurality of lenses, at least one lens being disposed so as to focus light from the light source up at least one of the light passing spires.

7. The ornament of claim 6, wherein the at least one lens focuses light from the light source up the at least one light passing spire so as to increase the amount of light emitted by the portions of the spire further from the base.

8. The ornament of claim 6, wherein at least one of the plurality of lenses is partially disposed within at least one of the light passing spires.

9. The ornament of claim 6, wherein at least one of the plurality of lenses is partially disposed within at least one of the sockets.

10. The ornament of claim 6, wherein at least one of the plurality of lenses is partially disposed within the hollow core.

11. The ornament of claim 6, wherein each light passing spire further comprises:
a plurality of light steps oriented so as to receive light from the light source via the hollow of the spire;
a plurality of facets, each facet oriented so as to receive light from at least one of the light steps.

12. The ornament of claim 11, wherein each one of the light steps has an area and a distance from the light source, and wherein the relative areas of the light steps are functions of relative distances from the light source.

13. The ornament of claim 12, wherein the relationship is the inverse square law.

14. The ornament of claim 6, wherein the spires are rigid.

15. The ornament of claim 6, wherein the spires are flexible.

16. The ornament of claim 6, wherein each spire is dimensioned and configured, and each socket is dimensioned and configured, such that each spire may be individually removed from the socket to which it is physically connected.

17. The ornament of claim 16, wherein the socket and spire base each have at least one notch and at least one tab which overlap when then the spire base is inserted into the socket and rotated.

18. The ornament of claim 6, wherein the exterior of the spires comprises a texture selected from the group consisting of: smooth texture, faceted texture, knurled texture, straight grooved texture, spiraled grooved texture, and combinations thereof.

19. The ornament of claim 6, wherein the spires further comprise a material selected from the group consisting of: clear polycarbonate, transparent colored polycarbonate, pearlescent polycarbonate, clear polymer, transparent colored polymer, translucent polymer, pearlescent polymer, clear glass, transparent colored glass, translucent glass, pearlescent glass, and combinations thereof.

20. The ornament of claim 19, wherein the polymer is selected from the group consisting of clear hard PVC, acrylic, PETG, LDPE, HDPE, and combinations thereof.

21. The ornament of claim 6, wherein each spire further comprises: at least one removable light passing sheath covering the exterior surface of the spire, wherein the light passing sheath is selected from the group consisting of: clear polycarbonate, transparent colored polycarbonate, pearlescent polycarbonate, clear polymer, transparent colored polymer, translucent polymer, pearlescent polymer, clear glass, transparent colored glass, translucent glass, pearlescent glass, and combinations thereof.

22. The ornament of claim 6, wherein the light source is colored.

23. The ornament of claim 6, further comprising means for timed control of the electrical supply of the light source.

24. The ornament of claim 6, further comprising:
at least one electrically actuated sound device in operative connection to the electrical cord, whereby the device may make sound when in operation.

25. The ornament of claim 6, wherein a first one of the plurality of spires has a first length, and a second one of the plurality of spires has a second length.

26. The ornament of claim 6, further comprising a photoelectric control circuit regulating electrical supply to the light source based upon ambient light.

27. The ornament of claim 6, wherein the hollow core has a plurality of decorative exterior facets.

28. The ornament of claim 6, wherein at least one of the spires has a plurality of decorative exterior facets.

29. A hanging holiday ornament comprising:
an electrical cord having a plug at a first end, the electrical cord terminating at a light source at the second end;
a hollow core having a plurality of sockets and having disposed therein the light source;
a plurality of light passing spires extending radially from the core; each spire physically connected to one of the sockets, and
at least one fiber optic bundle disposed within at least one such spire, the base of the fiber optic bundle located at the end of the spire located at the hollow core and disposed so as to receive light rays from the light source.
